(19) United States
(12) Patent Application Publication
(10) Pub. No.: US 2018/0018965 A1
(43) Pub. Date: Jan. 18, 2018

(54) Combining Gesture and Voice User Interfaces

(71) Applicant: Bose Corporation, Framingham, MA (US)

(72) Inventor: Michael J. Daley, Shrewsbury, MA (US)

(73) Assignee: Bose Corporation, Framingham, MA (US)

(21) Appl. No.: 15/646,446

(22) Filed: Jul. 11, 2017

Related U.S. Application Data
(60) Provisional application No. 62/361,257, filed on Jul. 12, 2016.

(51) Int. Cl. G10L 15/22; G06F 3/16; G06F 3/01; G10L 15/24; G10L 15/30

(52) U.S. Cl. CPC G10L 15/22; G10L 15/24; G10L 15/30; G06F 3/017; G06F 3/167; G06F 3/165; G10L 2015/223

(57) ABSTRACT

A system includes a microphone providing input to a voice user interface (VUI), a motion sensor providing input to a gesture-based user interface (GBI), an audio output device, and a processor in communication with the VUI, the GBI, and the audio output device. The processor detects a predetermined gesture input to the GBI, and in response to the detection, decreases the volume of audio being output by the audio output device and activates the VUI to listen for a command. A system includes an audio output device for providing audible output from a virtual personal assistant (VPA), a motion sensor input to a gesture-based user interface (GBI), and a processor in communication with the VPA and the GBI. The processor, upon receiving an input from the GBI after the audio output device provided output from the VPA, forwards the input received from the GBI to the VPA.

### PRIORITY CLAIM

This application claims priority to provisional U.S. application 62/361,257, filed Jul. 12, 2016, the entire contents of which are incorporated here by reference.

### BACKGROUND

This disclosure relates to combining gesture-based and voice-based user interfaces.

Currently-deployed home automation and home entertainment systems may use a variety of user interfaces. In addition to traditional remote controls and physical controls on devices to be controlled, some systems now use voice user interfaces (VUI) and gesture-based user interfaces (which we call “GBI,” to avoid confusion with GUI for “graphical user interface”). In a VUI, a user may speak commands, and the system may respond by speaking back, or by taking action. In a GBI, the user makes some gesture, such as waving a remote control or their own hand, and the system responds by taking action.

In some VUIs, a special phrase, referred to as a “wakeup word,” “wake word,” or “keyword” is used to activate the speech recognition features of the VUI—the device implementing the VUI is always listening for the wakeup word, and when it hears it, it parses whatever spoken commands came after it.

### SUMMARY

In general, in one aspect, a system includes a microphone providing input to a voice user interface (VUI), a motion sensor providing input to a gesture-based user interface (GBI), an audio output device, and a processor in communication with the VUI, the GBI, and the audio output device. The processor detects a predetermined gesture input to the GBI, and in response to the detection, decreases the volume of audio being output by the audio output device and activates the VUI to listen for a command.

Implementations may include one or more of the following, in any combination. Upon detecting a second predetermined gesture input to the GBI, the processor may restore the volume of audio being output by the audio output device to its previous level. The motion sensor may include one or more of an accelerometer, a camera, RADAR, LIDAR, ultrasonic sensors, or an infra-red detector. The processor may be configured to decrease the volume and activate the VUI only when the audio output device was outputting audio at a level above a predetermined level at the time the predetermined gesture was detected. The microphone, the motion sensor, and the audio output device may each be provided by separate devices each connected to a network. The processor may be in a device that includes one of the microphone, the motion sensor, and the audio output device. The processor may be in an additional device connected to each of the microphone, the motion sensor, and the audio output device over the network. The microphone, the motion sensor, and the audio output device may each be components of a single device. The single device may also include the processor. The single device may be in communication with the processor over a network.

In general, in one aspect, a system includes an audio output device for providing audible output from a virtual personal assistant (VPA), a motion sensor input to a gesture-based user interface (GBI), and a processor in communication with the VPA and the GBI. The processor, upon receiving an input from the GBI after the audio output device provided output from the VPA, forwards the input received from the GBI to the VPA.

Advantages include allowing a user to mute or duck audio, so that voice input can be heard, without having to first shout to be heard over the un-muted audio. Advantages also include allowing a user to respond silently to prompts from a voice interface.

All examples and features mentioned above can be combined in any technically possible way. Other features and advantages will be apparent from the description and the claims.

### BRIEF DESCRIPTION OF THE DRAWINGS

FIG. 1 shows a system layout of microphones and motion sensors and devices that may respond to voice or gesture commands received by the microphones or detected by the motion sensors.

### DESCRIPTION

One of the tasks performed by voice-controlled systems is to control audio systems, such as by playing requested music, and turning the volume up and down. A problem arises, however, when the volume is already high—the voice user interface (VUI) cannot hear further spoken commands, including one to turn down the volume. In other examples, a user may be able to hear information from a VUI that needs a response, but be unable or unwilling to speak out loud, or to be heard by the VUI if doing so. To resolve these conflicts, the combination of gesture and voice controls in a single user interface is disclosed.

Specifically, when the gesture-based user interface (GBI) detects a gesture that indicates that volume should be reduced, it not only complies with that request, it primes the VUI to start receiving spoken input. This may include immediately treating an utterance as a command (rather than screening for a wakeup word), activating a microphone at the location where the gesture was detected, or aiming a configurable microphone array at that location. The system does continue to listen for wakeup words, and if it hears one through the noise it will respond similarly, by reducing volume and priming the VUI to receive further input.

In other examples, a VUI may serve the role of a virtual personal assistant (VPA), and proactively provide information to a user or seek the user's input. In situations where a user is wearing headphones so that their audio does not disturb others, they may not want to speak to their VPA, but they do want to receive information from it and respond to its prompts. In this case, gestures are used to respond to the VPA, while the VPA itself remains in voice-response mode. Such gestures may include nodding or shaking the head, which can be detected by accelerometers in the headphones, or by cameras located on or external to the headphone. Cameras on the headphone, normally used for recording or transmitting the user's environment, such as for a telepresence or Augmented-Reality (AR) system, may detect motion of the user's head by noting the sudden gross movement of the observed environment. External cameras, of course, can simply observe the motion of the user's head. Either type of camera can also be used to detect hand gestures.

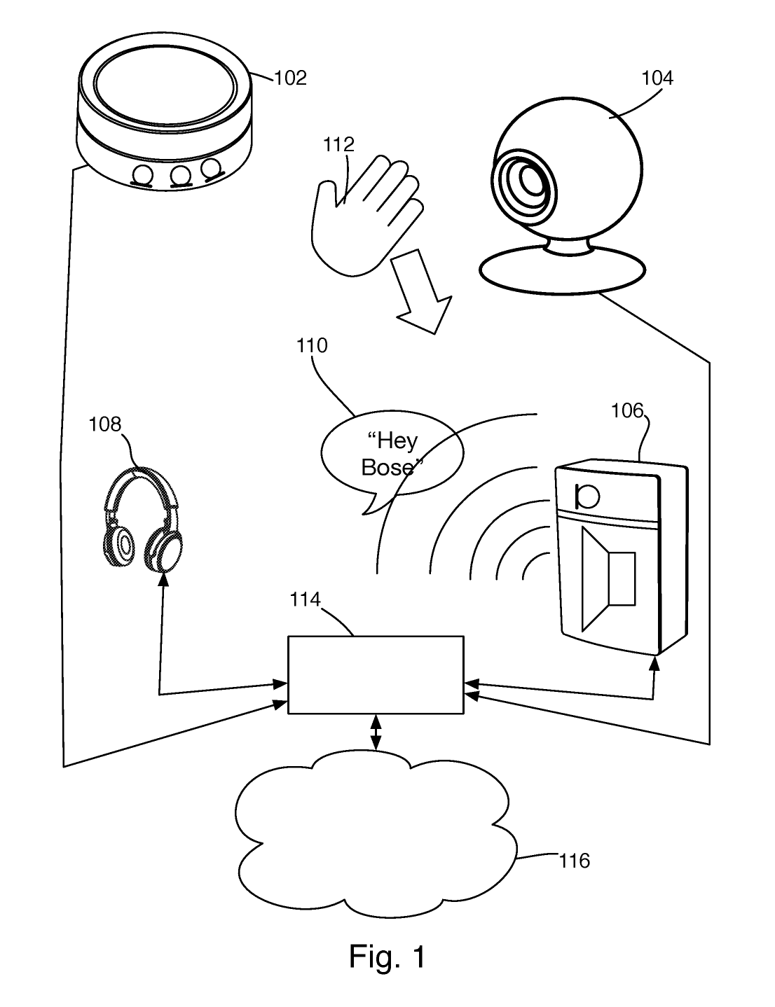

FIG. 1 shows a potential environment, with a stand-alone microphone array 102, a camera 104, a loudspeaker 106, and a set of headphones 108. At least some of the devices have microphones that detect a user's utterances 110 (to avoid confusion, we refer to the person speaking as the “user” and the device 106 as a “loudspeaker;” discrete things spoken by the user are “utterances”), and at least some have sensors that detect the user's motion 112. The camera 104, obviously, has a camera; other motion sensors besides cameras may also be used, such as accelerometers in the headphones, capacitive or other touch sensors on any of the devices, and infra-red, RADAR, LIDAR, ultrasonic, or other non-camera motion sensors. In the case of the devices having multiple microphones, those devices may combine the signals rendered by the individual microphones to render single combined audio signal, or they may transmit a signal rendered by each microphone.

A central hub 114, which may be integrated into the speaker 106, headphones 108, or any other piece of hardware, is in communication with the various devices 102, 104, 106, 108. In the first example mentioned above, the hub 114 is aware that the speaker 106 is playing music, so when the camera reports a predetermined gesture 112, such as a sharp downward motion of the user's hand, or a hand held up in a “stop” gesture, it tells the speaker 106 to duck the audio, so that the microphone array 102 or the speaker's own microphone can hear the utterance 110. A counter gesture—raising an open hand upward, or lowering the raised “stop” hand, respectively, for the two previous examples—may cause the audio to be resumed. In some examples, the camera 104 itself interprets the motion it detects and reports the observed gesture to the hub 112. In other examples, the camera 104 merely provides a video stream or data describing observed elements, and the hub 112 interprets it.

In the second example mentioned above, the headphones 108 may be providing audible output from the VPA (not shown, potentially implemented in the hub 112, from a network 116, or in the headphones themselves). When the user needs to respond, but does not want to speak, they shake or nod their head. If the headphones have accelerometers or other sensors for detecting this motion, they report it to the hub 114, which forwards it to the VPA (it is possible that both the hub and VPA are integrated into the headphones). In other examples, cameras, either in the headphones or the camera 104, report the head motion to the hub and VPA. This allows the user to respond to the VPA without speaking and without having to interact with another user interface device.

The gesture/voice user interfaces may be implemented in a single computer or a distributed system. Processing devices may be located entirely locally to the devices, entirely in the cloud, or split between both. They may be integrated into one or all of the devices. The various tasks described—detecting gestures, detecting wakeup words, sending a signal to another system for handling, parsing the signal for a command, handling the command, generating a response, determining which device should handle the response, etc., may be combined together or broken down into more sub-tasks. Each of the tasks and sub-tasks may be performed by a different device or combination of devices, locally or in a cloud-based or other remote system.

When we refer to microphones, we include microphone arrays without any intended restriction on particular microphone technology, topology, or signal processing. Similarly, references to loudspeakers and headphones should be understood to include any audio output devices—televisions, home theater systems, doorbells, wearable speakers, etc.

Embodiments of the systems and methods described above comprise computer components and computer-implemented steps that will be apparent to those skilled in the art. For example, it should be understood by one of skill in the art that instructions for executing the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A system comprising:
a microphone providing input to a voice user interface (VUI);
a motion sensor providing input to a gesture-based user interface (GBI);
an audio output device; and
a processor in communication with the VUI, the GBI, and the audio output device, and configured to:
detect a predetermined gesture input to the GBI, and
in response to the detection, decrease volume of audio being output by the audio output device, and
activate the VUI to listen for a command.

2. The system of claim 1, wherein the processor is further configured to:
detect a second predetermined gesture input to the GBI, and
in response to the detection, restore the volume of audio being output by the audio output device to its previous level.

3. The system of claim 1, wherein the motion sensor comprises one or more of an accelerometer, a camera, RADAR, LIDAR, ultrasonic sensors, or an infra-red detector.

4. The system of claim 1, wherein the processor is configured to decrease the volume and activate the VUI only when the audio output device is outputting audio at a level above a predetermined level at the time the predetermined gesture is detected.

5. The system of claim 1, wherein the microphone, the motion sensor, and the audio output device are each provided by separate devices each connected to a network.

6. The system of claim 5, wherein the processor is in a device that includes one of the microphone, the motion sensor, and the audio output device.

7. The system of claim 5, wherein the processor is in an additional device connected to each of the microphone, the motion sensor, and the audio output device over the network.

8. The system of claim 1, wherein the microphone, the motion sensor, and the audio output device are each components of a single device.

9. The system of claim 8, wherein the single device also comprises the processor.

10. The system of claim 8, wherein the single device is in communication with the processor over a network.

11. A system comprising:
an audio output device for providing audible output from a virtual personal assistant (VPA);
a motion sensor input to a gesture-based user interface (GBI); and
a processor in communication with the VPA and the GBI, and configured to:
upon receiving an input from the GBI after the audio output device provided output from the VPA, forward the input received from the GBI to the VPA.

12. A method comprising:
while outputting audio through an audio output device,
upon receiving an indication that a predetermined gesture has been detected by a motion sensor providing input to a gesture-based user interface (GBI),
decreasing volume of the audio being output by the audio output device, and
activating a voice user interface (VUI) to listen for a command through a microphone.
